(19) United States
(12) Patent Application Publication
(10) Pub. No.: US 2013/0265120 A1
(43) Pub. Date: Oct. 10, 2013

(54) MICROSTRIP PHASE INVERTER

(71) Applicants: Wee Sang Park, Pohang-si (KR); Jae Hee Kim, Pohang-si (KR); Dae Woong Woo, Pohang-si (KR)

(72) Inventors: Wee Sang Park, Pohang-si (KR); Jae Hee Kim, Pohang-si (KR); Dae Woong Woo, Pohang-si (KR)

(73) Assignee: POSTECH ACADEMY-INDUSTRY FOUNDATION, Pohang-si, Gyungbuk (KR)

(21) Appl. No.: 13/877,620

(22) PCT Filed: Nov. 19, 2010
(86) PCT No.: PCT/KR10/08170

§ 371 Date: Apr. 3, 2013

(30) Foreign Application Priority Data
Nov. 24, 2009 (KR) 10-2009-0114065

(51) Int. Cl. H01P 1/18

(52) U.S. Cl. CPC H01P 1/184
USPC 333/161

(57) ABSTRACT

A microstrip phase inverter includes: a ground substrate having a slot formed therein; a dielectric layer formed over the ground substrate; a first microstrip line connected to a signal line of a first port and stacked and extended on the top surface of the dielectric layer at one side thereof; a second microstrip line facing the first microstrip line so as to deviate from the first microstrip line, connected to a signal line of a second port, and stacked and extended on the top surface of the dielectric layer at the other side thereof; and first and second via pins connected between one ends of the extended first and second microstrip lines and the ground substrate and configured to transmit first and second currents.

### BACKGROUND OF THE INVENTION

1. Field of the Invention

The present invention relates to a phase inverter, and more particularly, to a microstrip phase inverter that directly inverts a phase without a converter for converting a line which is required when a conventional phase inverter is applied to a microstrip line.

2. Description of the Related Art

A general method for changing the phase of a signal transmitted in a microwave band is to adjust the length of a transmission line. For example, when the length of the transmission line is increased by ½ wavelength, the phase of a signal is delayed by 180 degrees, that is, the phase of the signal is inverted. However, when the length of the transmission line is increased to invert the phase of a signal, the volume of the entire system is inevitably increased.

Therefore, when a phase inverter is used as a device which changes the phase of an input signal by 180 degrees while maintaining the size of the input signal, the phase of the input signal may be changed by a system having a relatively small size. Such a phase inverter may be applied to a 180-degree hybrid coupler, a branch line coupler, a band-pass filter and the like in a microwave band, thereby reducing the size of the systems. Furthermore, when the length of the systems is reduced, a phase variation with respect to frequency decreases to thereby increase a bandwidth.

FIG. 1 illustrates a conventional parallel-line phase inverter, and FIG. 2 is a schematic view for explaining a conventional coplanar-line phase inverter. The parallel-line phase inverter of FIG. 1 is configured by connecting two parallel lines through via pins 10 and 11, with a dielectric layer interposed therebetween. Between the two parallel lines, the upper line includes signal lines 12 and 13 through which signals are passed, and the lower line includes ground lines 14 and 15. A current flowing along the signal lines 12 and 13 is transmitted to the ground lines 14 and 15 through the via pins 10 and 11, and a current flowing along the ground lines 14 and 15 is transmitted to the signal lines 13 and 12 through the via pins 10 and 11. Therefore, since currents are passed in a reverse direction based on the via pins 10 and 11, the phase of the signal may be inverted by 180 degrees.

Similarly, in the coplanar-line phase converter of FIG. 2, a signal current of a signal line 16 is passed to a ground line 19, and a current flowing in a signal line 17 is passed to a ground line 18 through a via pin 20 such that the signal phase is inverted by 180 degrees. The ground lines included in the above-described two phase inverters have the same width as the signal lines.

However, a microstrip line includes a signal line, a ground line, and a dielectric substance interposed therebetween. The ground line is disposed to correspond to the signal line, and implemented as a ground substrate. Such a microstrip line may be applied to a microwave passive element. In order to invert the phase of a signal in the microstrip line, the conventional microwave passive element requires a separate device to convert the microstrip line into a parallel line. Therefore, the volume of the conventional microwave passive element is inevitably increased.

### SUMMARY OF THE INVENTION

Accordingly, the present invention has been made in an effort to solve the problems occurring in the related art, and an object of the present invention is to provide a microstrip phase inverter that directly inverts the phase of a signal of a microstrip line without an additional line converter.

In order to achieve the above object, according to one aspect of the present invention, there is provided a microstrip phase inverter including: a ground substrate having a slot formed therein; a dielectric layer formed over the ground substrate; a first microstrip line connected to a signal line of a first port and stacked and extended on the top surface of the dielectric layer at one side thereof; a second microstrip line facing the first microstrip line so as to deviate from the first microstrip line, connected to a signal line of a second port, and stacked and extended on the top surface of the dielectric layer at the other side thereof; and first and second via pins connected between one ends of the extended first and second microstrip lines and the ground substrate and configured to transmit first and second currents. The slot is formed in the ground substrate such that the first and second currents flowing in the ground substrate through the first and second via pins are separated from each other so as to form electrical fields with the second and first microstrip lines, respectively.

The slot may be formed in the ground substrate so as to be connected along a direction crossing the first and second microstrip lines and a direction crossing the space between the first and second via pins, except portions connected to the first and second via pins.

The length of the slot may be set to a value at which resonance occurs at the frequency of signals transmitted from the first and second microstrip lines.

The length of the slot may be 0.4 to 0.8 times than the wavelength of signals transmitted to the first and second microstrip lines.

The slot may be formed in a zigzag shape. The slot may have a width of 0.05 mm to 0.5 mm.

### BRIEF DESCRIPTION OF THE DRAWINGS

The above objects, and other features and advantages of the present invention will become more apparent after a reading of the following detailed description taken in conjunction with the drawings, in which:

FIG. 1 is a schematic view for explaining a conventional parallel-line phase inverter;

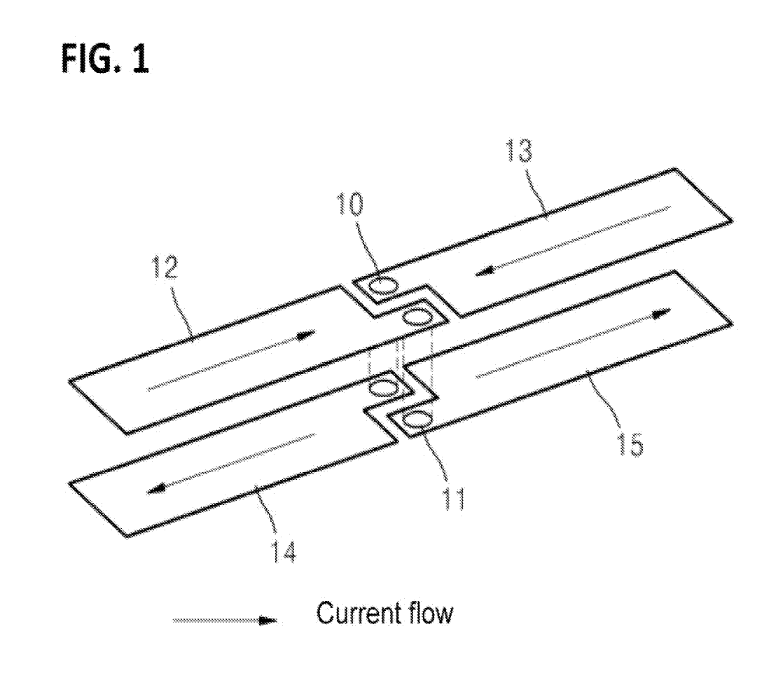

FIG. 2 is a schematic view for explaining a conventional coplanar-line phase inverter;

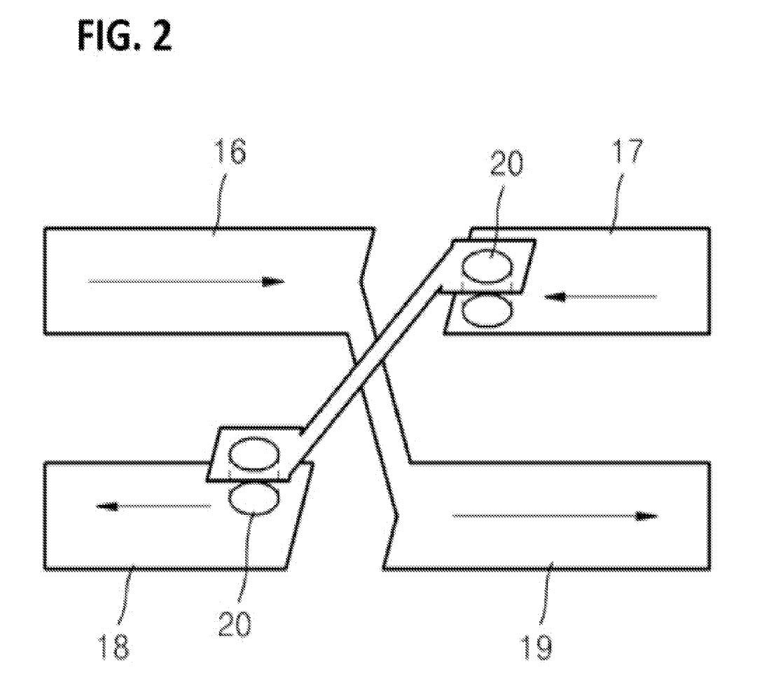

FIG. 3 is a schematic view of a microstrip phase inverter according to an embodiment of the present invention;

FIG. 4 is a cross-sectional view of the microstrip phase converter of FIG. 3, taken along an I-direction;

FIG. 5 illustrates an equivalent circuit model for explaining the operation principle of the phase inverter according to the embodiment of the present invention;

FIG. 6 is a graph illustrating S-parameters and phase values of the equivalent circuit model and the microstrip phase inverter according to the embodiment of the present invention; and

FIG. 7 is a graph comparatively illustrating performances of the phase inverter according to the embodiment of the present invention and a microstrip transmission line to which the phase inverter is not applied.

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

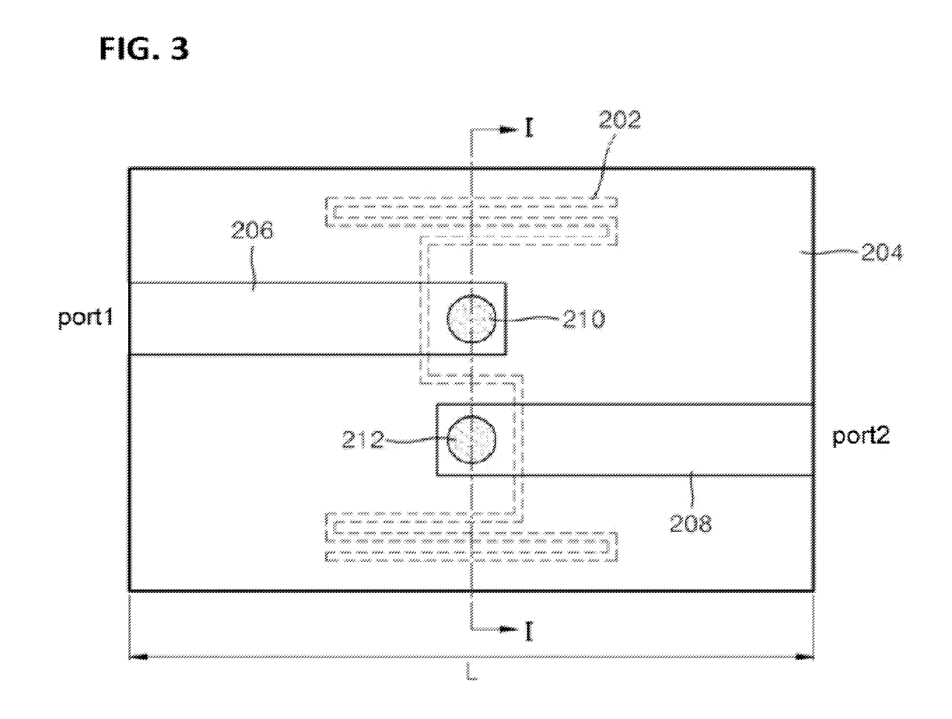

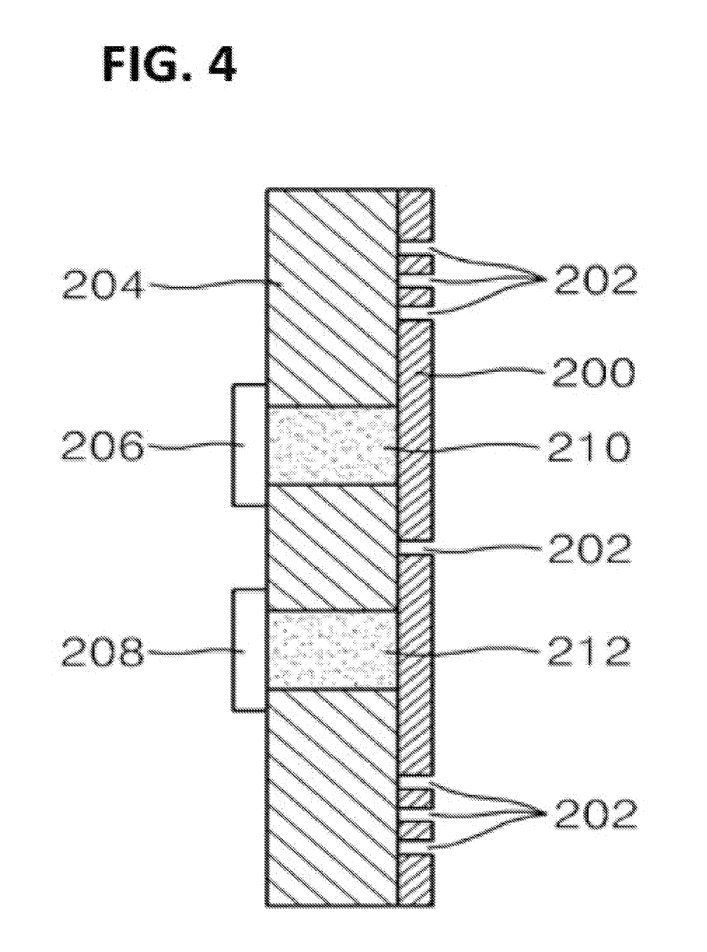

FIG. 3 is a schematic view of a microstrip phase inverter according to an embodiment of the present invention. FIG. 4 is a cross-sectional view of the microstrip phase converter of FIG. 3, taken along an I-direction.

The microstrip phase converter includes a ground substrate 200, a slot 202, and a dielectric layer 204. The ground substrate 200 is configured to transmit a signal. The slot 202 is configured to block a signal flow in a ground substrate. The dielectric layer 204 is stacked over the ground substrate 200. Furthermore, the microstrip phase converter of FIG. 3 includes a first microstrip line 206 stacked and extended on the top surface of the dielectric layer 204 from one side thereof and a second microstrip line 208 stacked and extended on the top surface of the dielectric layer 204 from the other side thereof. The first and second microstrip lines 206 and 208 are positioned to face each other but deviate from each other. Furthermore, the microstrip phase converter includes first and second via pins 210 and 212 connected between extended one ends of the first and second microstrip lines 206 and 208 and the ground substrate 200 so as to transmit signals.

The first and second via pins 210 and 212 are connected to the ground substrate 200 and extended terminals of the first and second microstrip lines 206 and 208, respectively, like the conventional phase inverter. The first and second via pins 210 and 212 serve to pass currents flowing in the microstrip lines 206 and 208 to the ground substrate 200 which is divided by the slot 202 to block a signal.

The slot 202 is formed in the ground substrate 200 so as to be connected along a direction crossing the first and second microstrip lines 206 and 208 and a direction crossing a space between the first and second via pins 210 and 212, except for portions connected to the first and second via pins 210 and 212. Accordingly, the slot 202 blocks a signal flow between the first and second via pins 210 and 212. Therefore, when the slot 202 resonates at the frequency of a transmitted signal, signal currents flowing from ports 1 and 2 to the first and second microstrip lines 206 and 208 form an electric field between the second and first microstrip lines 208 and 206 and the ground substrate 200 through the via pins 210 and 212 separated from each other with the slot 202 set to the boundary therebetween. As a result, the signal currents are passed to the divided parts of the ground substrate 200, respectively. Accordingly, the phase inversion may be achieved at a signal frequency where the slot 202 resonates, without a signal loss.

In the embodiment of the present invention, signals transmitted through the slot 202 may be radiated, and signals between the two signal lines may not be normally transmitted. Therefore, the design of the slot 202 is important. When the slot 202 has a large width or is formed in a straight line, radiation occurs through the slot. Therefore, the slot 202 may be formed in a zigzag shape to reduce the effect of radiation, and may have a small width of 0.05 mm to 0.5 mm.

The strip phase inverter according to the embodiment of the present invention was manufactured by using a substrate having a dielectric constant of 2.2 and a thickness of 0.508 mm. The widths of the first and second microstrip lines 206 and 208 were set to 1.55 mm such that the impedance becomes 50Ω, and the diameters of the via pins 210 and 212 were set to 0.3 mm. The longitudinal length L of the ground substrate 200 was set to 30 mm, the slot 202 was designed to resonate at 2.34 GHz, and the length of the slot 202 was set to 86 mm. In the slot 202, resonance generally occurs at a length corresponding to a half wavelength. However, when a zigzag shape is applied to the slot 202, resonance occurs at a larger length. Therefore, the slot is set to have a length slightly larger than the half wavelength.

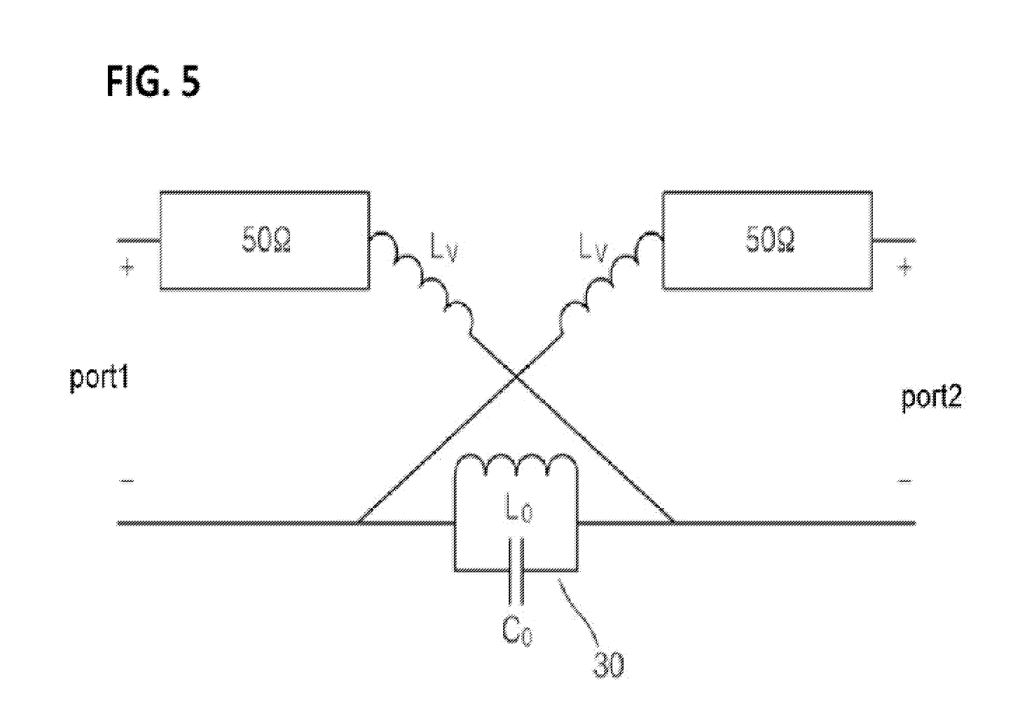

FIG. 5 illustrates an equivalent circuit model for explaining the operation principle of the phase inverter according to the embodiment of the present invention. The equivalent circuit model includes serial inductances Lᵥ and a parallel resonance circuit 30 having an inductance L₀ and a capacitance c₀C. The serial inductances Lᵥ indicate inductance components formed by the first and second via pins 210 and 212, and the parallel resonance circuit 30 indicates resonance caused by the slot 202. The element values of the equivalent circuit model may be decided by the resonant frequency of the slot 202 and a phase difference. Based on the designed values, the element values of the equivalent circuit model may be extracted as follows: Lᵥ=0.4 nH, L₀=5 nH, and C₀=1.43 pH.

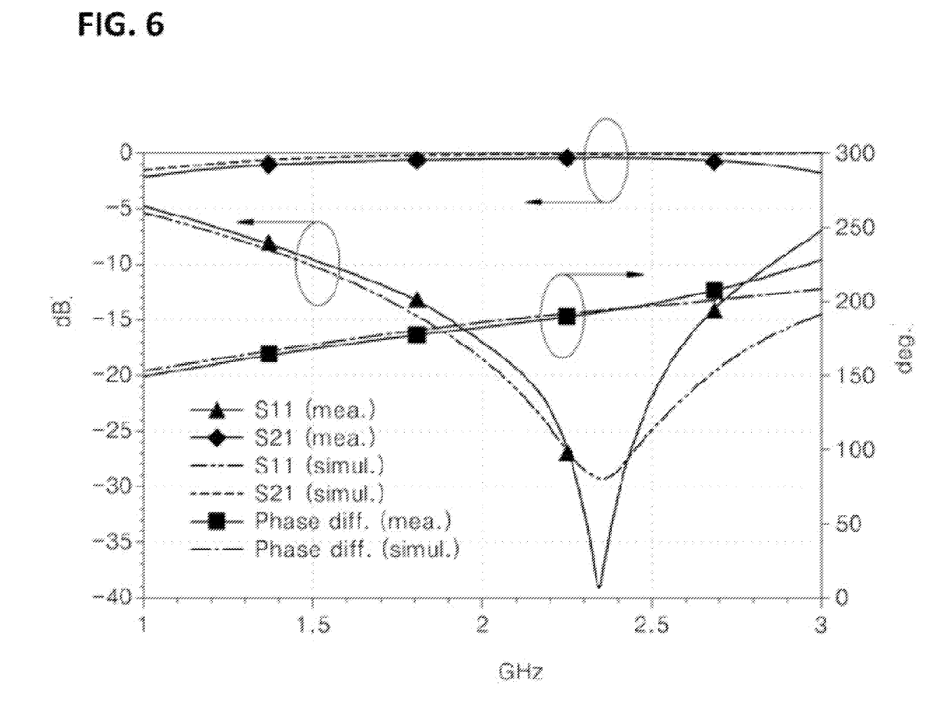

FIG. 6 is a graph illustrating S-parameters and phase values of the equivalent circuit model and the microstrip phase inverter according to the embodiment of the present invention. Referring to FIG. 6, it can be seen that calculated values based on the equivalent circuit model and measured values of the microstrip phase inverter according to the embodiment of the present invention coincide with each other. In FIG. 6, S11 represents a reflection coefficient, S21 represents a maximum transmission coefficient, and phase diff. represents a phase difference obtained by subtracting the phase of a transmission line from the phase of the phase inverter. When the phase difference corresponds to 180 degrees, it indicates that the phase inversion was normally performed. Referring to FIG. 6, it can be seen that the phase inversion was normally performed, because the phase difference around a resonant frequency of 2.34 GHz ranges 190 to 200°.

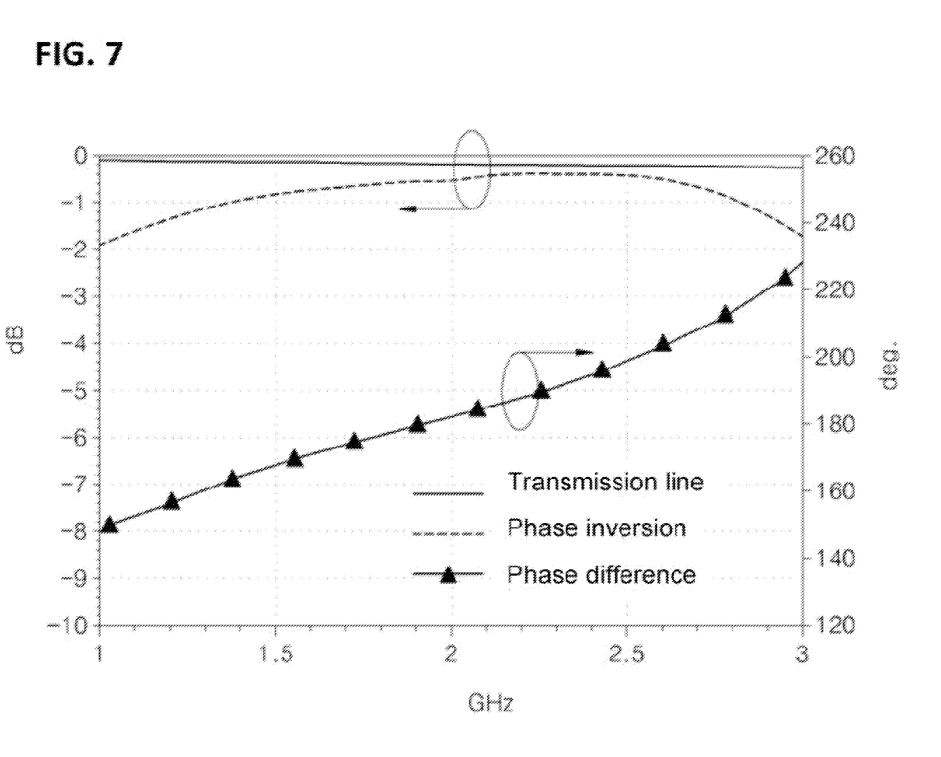

FIG. 7 is a graph comparatively illustrating performances of the phase inverter according to the embodiment of the present invention and a microstrip transmission line to which the phase inverter is not applied.

At a resonant frequency of 2.34 GHz, a maximum transmission coefficient S21 of the phase inverter is 0.39 dB, and a phase difference is 193°. Furthermore, a transmission coefficient of the microstrip line at the same frequency is −0.23 dB. In an ideal case, the phase difference is 180°. However, an additional phase delay of 13° occurs due to the via pins. Accordingly, as the length of the transmission line including the phase inverter is slightly reduced, the phase difference may be corrected to become 180°.

Furthermore, as the phase inverter according to the embodiment of the present invention is applied, the transmission coefficient was decreased to −0.16 dB. However, the value may be sufficiently accepted. Furthermore, when the maximum transmission coefficient of the phase inverter falls within a difference of 0.3 dB and the phase difference falls within ±5°, the bandwidth of the phase inverter corresponds 11%. These values may be sufficiently applied to a phase inverter which is integrated in a microwave passive element.

The microstrip phase inverter according to the embodiment of the present invention does not require an additional device to convert a microstrip line. Furthermore, since the microstrip line is used to directly invert the phase of a transmitted signal, the phase of the signal may be converted by a small-size system.

The embodiment of the present invention may be applied to a microstrip phase inverter which directly inverts the phase of a signal without a converter that changes a transmission line required when a conventional phase inverter is applied to the microstrip transmission line.

Although a preferred embodiment of the present invention has been described for illustrative purposes, those skilled in the art will appreciate that various modifications, additions and substitutions are possible, without departing from the scope and the spirit of the invention as disclosed in the accompanying claims.

What is claimed is:

1. A microstrip phase inverter comprising:
a ground substrate having a slot formed therein;
a dielectric layer formed over the ground substrate;
a first microstrip line connected to a signal line of a first port and stacked and extended on the top surface of the dielectric layer at one side thereof;
a second microstrip line facing the first microstrip line so as to deviate from the first microstrip line, connected to a signal line of a second port, and stacked and extended on the top surface of the dielectric layer at the other side thereof; and
first and second via pins connected between one ends of the extended first and second microstrip lines and the ground substrate and configured to transmit first and second currents,
wherein the slot is formed in the ground substrate such that the first and second currents flowing in the ground substrate through the first and second via pins are separated from each other so as to form electrical fields with the second and first microstrip lines, respectively.

2. The microstrip phase inverter of claim 1, wherein the slot is formed in the ground substrate so as to be connected along a direction crossing the first and second microstrip lines and a direction crossing the space between the first and second via pins, except portions connected to the first and second via pins.

3. The microstrip phase inverter of claim 1, wherein the length of the slot is set to a value at which resonance occurs at the frequency of signals transmitted from the first and second microstrip lines.

4. The microstrip phase inverter of claim 1, wherein the length of the slot is 0.4 to 0.8 times than the wavelength of signals transmitted to the first and second microstrip lines.

5. The microstrip phase inverter of claim 1, wherein the slot is formed in a zigzag shape.

6. The microstrip phase inverter of claim 1, wherein the slot has a width of 0.05 mm to 0.5 mm.
